(19) United States
(12) Patent Application Publication
(10) Pub. No.: US 2019/0203839 A1
(43) Pub. Date: Jul. 4, 2019

(54) DOUGH PENETRATION PREVENTION DEVICE OF KNEADING MACHINE

(71) Applicant: SUNG LOK SEU, Seoul (KR)

(72) Inventor: SUNG LOK SEU, Seoul (KR)

(21) Appl. No.: 16/175,058

(22) Filed: Oct. 30, 2018

(30) Foreign Application Priority Data
Dec. 28, 2017 (KR) 10-2017-0182403

(51) Int. Cl. F16J 15/3232; A21C 1/06; A21C 1/14; F16J 15/3268

(52) U.S. Cl. CPC F16J 15/3232; F16J 15/3268; A21C 1/1415; A21C 1/06

(57) ABSTRACT

A dough penetration prevention device of a kneading machine includes a lip seal ring having seal ring wings integrally formed on an inner circumferential surface of the lip seal ring and fixed to a bearing housing, a head seal body on the sleeve in front of the bearing housing and fixed by a fixing body, to supply steam at a pressure level equal to the pressure of the kneading container into an opposite gap (t) between an outer circumferential surface of the sleeve and the lip seal ring, in opposition to the steam pressure of the kneading container attempting to penetrate into a gap (t) between the seal ring wings of the lip seal ring and the outer circumferential surface of the sleeve, and a steam supply and discharge part discharging condensed water to the outside while supplying steam to an inner circumferential surface of the head seal body.

### CROSS-REFERENCE TO RELATED APPLICATION(S)

This application claims the benefit under 35 USC § 119(a) of Korean Patent Application No. 10-2017-0182403, filed on Dec. 28, 2017, in the Korean Intellectual Property Office, the entire disclosure of which is incorporated herein by reference for all purposes.

### BACKGROUND

### 1. Field

The present invention relates generally to a dough penetration prevention device of a kneading machine, and more particularly to a dough penetration prevention device of a kneading machine, which includes: a lip seal ring having a plurality of seal ring wings, which are integrally formed on an inner circumferential surface of the lip seal ring and are fixed to a bearing housing, so as to prevent penetration of a dough, caused by steam pressure of a kneading container, into a main bearing in a bearing housing which is provided to assist rotation of a sleeve connected to a rotating shaft; a head seal body which is mounted on the sleeve in front of the bearing housing and is fixed by a fixing body, so as to supply steam at a pressure level equal to the pressure of the kneading container into an opposite gap between an outer circumferential surface of the sleeve and the lip seal ring, in opposition to the steam pressure of the kneading container attempting to penetrate into a gap between the seal ring wings of the lip seal ring and the outer circumferential surface of the sleeve; and a steam supply and discharge part which discharges condensed water, which is condensed by reacting with the steam of the kneading container, to the outside while supplying steam to an inner circumferential surface of the head seal body. Accordingly, by providing a lip seal ring having a plurality of seal ring wings which are integrally formed, the seal ring wings may be formed to have a larger thickness than that of a conventional seal ring wing, thereby improving sealing performance and extending the life of the lip seal ring, and the lip seal ring may be assembled to the bearing housing in a single process, thereby improving assembly productivity; by providing a head seal body mounted on the sleeve in front of the bearing housing to which the lip seal ring is connected, the lip seal ring may be isolated and prevented from coming into contact with the dough in the kneading container, and by providing a steam supply and discharge part which supplies steam, at a pressure level equal to the pressure of the kneading container, toward the kneading container to offset a pressure difference, such that the dough in the kneading container may be prevented from penetrating between the sleeve and the lip seal ring, thereby achieving excellent sealing performance, and preventing in advance deposition of scale of dough between the sleeve and the head seal body, and thus protecting the lip seal ring from the dough; and by providing a screw groove formed at an outer circumferential surface at one side of the sleeve, even when the dough penetrates into a gap between the head seal body and the sleeve, the screw groove rotates along with the sleeve, so as to push the penetrating portion of the dough toward the kneading container, thereby maintaining the gap between the head seal body and the sleeve in a clean state.

### 2. Description of Related Art

As a general kneading machine, Korean Laid-open Patent Publication No. 10-2011-0027497 discloses a “kneading machine”.

The kneading machine is configured in such a manner that: a kneading trough has, at one side, a rotating tube and a rotating shaft which rotate around the same center of rotation to project toward the inside of the kneading trough, in which a rotation speed of the rotating shaft is higher than that of the rotating tube; the rotating tube is installed by a bearing through the kneading trough and a support next to the kneading trough; and the bearing is also installed between the rotating shaft and the rotating tube which penetrate through the inside of the kneading trough; two stirring rods are installed at the rotating tube at a position spaced apart from the center of the rotating tube; and two or more tilted stirring wings are formed at an outer surface of the rotating shaft, so that a dough is pushed away from the rotating shaft during rotation.

The conventional kneading machine is illustrated in FIGS. 1 and 2.

In the general kneading machine, the rotating shaft 1, which rotates by a driving force of a motor, is supported by the bearing of a main body in a manner that facilitates rotation.

The rotating shaft 1 has, at one side, a stirring piece for stirring a dough in a kneading container; and has, at the other side, a power transfer device for transferring power of the motor to the rotating shaft 1.

Further, a sleeve 2 is connected to a position toward the dough container at the one side of the rotating shaft 1, so as to rotate along with the rotating shaft 1.

In addition, a main bearing 5 in a bearing housing 3 is connected to an outer circumferential surface of the sleeve 2, so as to support the sleeve 2 and the rotating shaft 1 while inducing smooth rotation of the sleeve 2.

Moreover, in a connection room 4 formed at one side of the bearing housing 3, a plurality of lip seal rings 7 are spaced apart from each other at predetermined intervals by a spacer 6, so that a dough in the kneading container may not penetrate toward the main bearing 5 through a gap between an inner surface of the bearing housing 3 and the outer circumferential surface of the sleeve 2.

In the conventional kneading machine described above, when the stirring piece stirs the dough in the kneading container by the rotation of the rotating shaft 1, the dough comes into contact with not only the rotating shaft 1 and the sleeve 2 but also a foremost wing of the lip seal ring 7 which is adhered to the outer circumferential surface of the sleeve 2.

As described above, the dough, which is in contact with the foremost wing of the lip seal ring 7, gradually hardens over time, thus forming scale of dough.

When the scale of dough is formed in the foremost wing of the lip seal ring 7, the scale rotates along with the sleeve 2, eating away at the foremost wing of the lip seal ring 7, and thus gradually wearing down the foremost wing.

Once the foremost wing of the lip seal ring 7 is worn down, the lip seal ring 7 no longer provides a sealing effect, resulting in penetration of the scale; and then the scale comes into contact with a second wing of the lip seal ring 7, wearing down the second wing and successively all the wings of the lip seal ring 7 in the end.

As the lip seal ring 7 fails to provide the sealing effect, the scale and even the dough may penetrate between the lip seal ring 7 and the outer circumferential surface of the sleeve 2, thereby easily penetrating into the main bearing 5 as described in FIG. 2.

For cleaning the scale, which hardens after depositing on the foremost wing of the lip seal ring 7 and the sleeve 2, there is a problem in that a tool of a rigid material, such as a scraper, is used to remove the scale, but the tool may damage the wing of the lip seal ring 7, such that the cleaning requires considerable attention.

Upon penetrating into the main bearing 5, the scale and the dough are mixed with grease, thereby causing frequent failure in the main bearing 5.

Furthermore, there is a drawback in that high-temperature steam, which is provided to facilitate a kneading operation of the kneading container, penetrates into the main bearing 5 along with the dough, such that the temperature of the main bearing 5 is increased from proper temperature of 60° C. to 70° C. to the high steam temperature of 130° C. to 150° C., thereby resulting in frequent failure in the main bearing 5.

In addition, there is also a drawback in that pressure of the high-temperature steam, which penetrates into the main bearing 5, may discharge the grease provided to the main bearing 5 to the outside, thereby reducing durability of the main bearing 5.

When the scale, the dough, and the steam penetrate into the kneading container, a problem occurs in that the kneading container requires a longer time for kneading, which reduces kneading productivity and the like.

### SUMMARY

In order to solve the above problems, it is an aspect of the present invention to provide:

a lip seal ring having a plurality of seal ring wings which are integrally formed, such that the seal ring wings may be formed to have a larger thickness than that of a conventional seal ring wing, thereby improving sealing performance and extending the life of the lip seal ring, and the lip seal ring may be assembled to the bearing housing in a single process, thereby improving assembly productivity; a head seal body mounted on the sleeve in front of the bearing housing to which the lip seal ring is connected, such that the lip seal ring may be isolated and prevented from coming into contact with the dough in the kneading container; a steam supply and discharge part which supplies steam, at a pressure level equal to the pressure of the kneading container, toward the kneading container to offset a pressure difference, such that the dough in the kneading container may be prevented from penetrating between the sleeve and the lip seal ring, thereby achieving excellent sealing performance, and preventing in advance deposition of scale of dough between the sleeve and the head seal body, and thus protecting the lip seal ring from the dough; and a screw groove formed at an outer circumferential surface at one side of the sleeve, such that even when the dough penetrates into a gap between the head seal body and the sleeve, the screw groove rotates along with the sleeve, so as to push the penetrating portion of the dough toward the kneading container, thereby maintaining the gap between the head seal body and the sleeve in a clean state.

In accordance with one aspect of the present invention, the above aspect is accomplished by providing a dough penetration prevention device of a kneading machine, including: a lip seal ring having a plurality of seal ring wings, which are integrally formed on an inner circumferential surface of the lip seal ring and are fixed to a bearing housing, so as to prevent penetration of a dough, caused by steam pressure of a kneading container, into a main bearing in a bearing housing which is provided to assist rotation of a sleeve connected to a rotating shaft; a head seal body which is mounted on the sleeve in front of the bearing housing and is fixed by a fixing body, so as to supply steam at a pressure level equal to the pressure of the kneading container into an opposite gap between an outer circumferential surface of the sleeve and the lip seal ring, in opposition to the steam pressure of the kneading container attempting to penetrate into a gap between the seal ring wings of the lip seal ring and the outer circumferential surface of the sleeve; and a steam supply and discharge part which discharges condensed water, which is condensed by reacting with the steam of the kneading container, to the outside while supplying steam to an inner circumferential surface of the head seal body.

### BRIEF DESCRIPTION OF THE DRAWINGS

FIG. 1 is a diagram explaining a sealing structure of a conventional kneading machine.

FIG. 2 is a diagram explaining a problem of the sealing structure of the conventional kneading machine.

FIG. 3 is a diagram illustrating a dough penetration prevention device mounted in a kneading machine of the present invention.

FIG. 4 is a diagram explaining an example of a configuration of the dough penetration prevention device of the present invention.

FIGS. 5 and 6 are diagrams explaining an operation of a dough penetration prevention device of the present invention.

FIG. 7 is a diagram explaining another example of a configuration and operation of the dough penetration prevention device of the present invention.

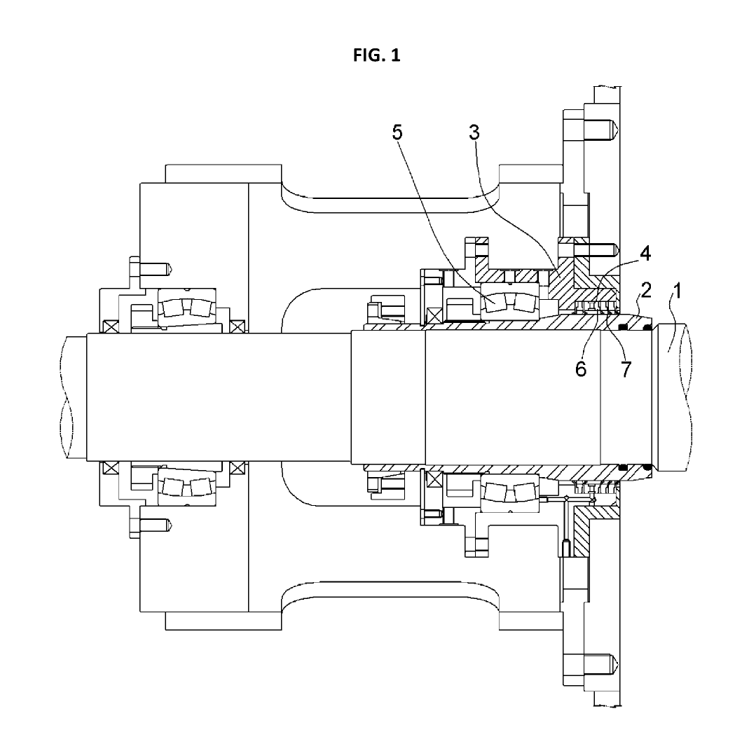

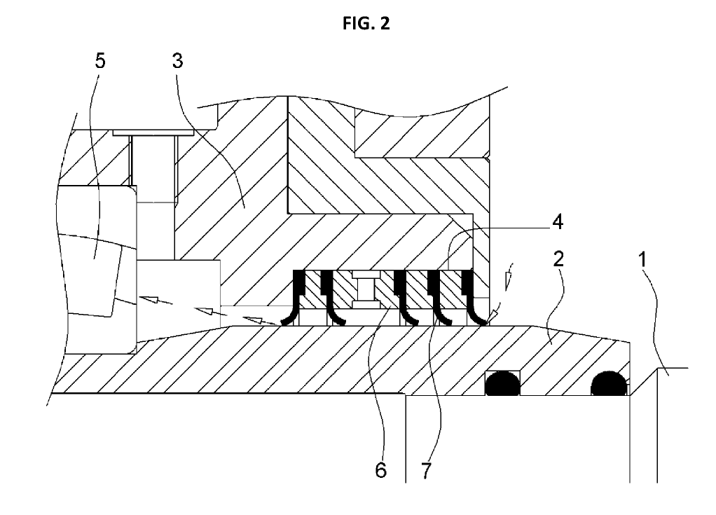

### DETAILED DESCRIPTION

A configuration of the present invention will be described in detail with reference to the accompanying drawings.

The kneading machine according to an embodiment of the present disclosure includes: a lip seal ring 101 having a plurality of seal ring wings 102, which are integrally formed on an inner circumferential surface of the lip seal ring 101 and are fixed to a bearing housing 121, so as to prevent penetration of a dough, caused by steam pressure of a kneading container 182, into a main bearing 126 in the bearing housing 121 which is provided to assist rotation of a sleeve 131 connected to the rotating shaft 181;

A head seal body 111 which is mounted on the sleeve 131 in front of the bearing housing 121 and is fixed by a fixing body 114, so as to supply steam at a pressure level equal to the pressure of the kneading container 182 into an opposite gap (t) between an outer circumferential surface of the sleeve 131 and the lip seal ring 101, in opposition to the steam pressure of the kneading container 182 attempting to penetrate into a gap (t) between the seal ring wings 102 of the lip seal ring 101 and the outer circumferential surface of the sleeve 131; and

A steam supply and discharge part which discharges condensed water, which is condensed by reacting with the steam of the kneading container 182 while supplying steam into an inner circumferential surface of the head seal body 111.

Further, the steam supply and discharge part includes a steam guide hole 112 which is formed at another side of the head seal body 111 and is supplied with steam;

A steam guide passage 122 which is formed at the bearing housing 121 connected to the steam guide hole 112, so as to supply steam at a predetermined pressure level to the steam guide hole 112;

An automatic opening-closing valve 171 mounted on a connection line 172 which is connected to the steam guide passage 122, so as to restrict an amount of steam supplied to the steam guide passage 122;

A condensed water discharge hole 113 formed on an opposite side of the steam guide hole 112 of the head seal body 111, so as to discharge the condensed water from steam which has been supplied to the steam guide hole 112 and has completed its function; and

A condensed water discharge passage 123 formed at the bearing housing 121 connected to the condensed water discharge hole 113, so as to discharge the condensed water of the condensed water discharge hole 113 to the outside.

In addition, a plurality of screw grooves 132 are further provided at the outer circumferential surface of the sleeve 131, so as to push the dough of the kneading container 182, which has penetrated into the gap between the inner circumferential surface of the head seal body 111 and the outer circumferential surface of the sleeve 131, toward the kneading container 182.

Moreover, a plurality of stopper-screws 141 are further provided, which are coupled to a plurality of screw holes 125 formed at a protruding portion of the bearing housing 121, so as to prevent the lip seal ring 101 from rotating along with the sleeve 131.

A first blocking seal ring 15 is further provided, which is connected between the head seal body 111 and the lip seal ring 101, so as to prevent the dough, having passed through a space between the head seal body 111 and the sleeve 131, from penetrating into the lip seal ring 101.

A second blocking seal ring 16 is further provided, which is mounted in an oil chamber 124 of the bearing housing 121, so as to prevent the dough, having passed through a space between the lip seal ring 101 and the sleeve 131, from penetrating into the main bearing 126.

In the configuration, not only the dough but also high-temperature water or compressed air, which penetrates from the kneading container 182, and the like, may be prevented from penetrating between the inner circumferential surface of the head seal body 111 and the outer circumferential surface of the sleeve 131.

The present invention, which is configured as described above, may be operated as follows.

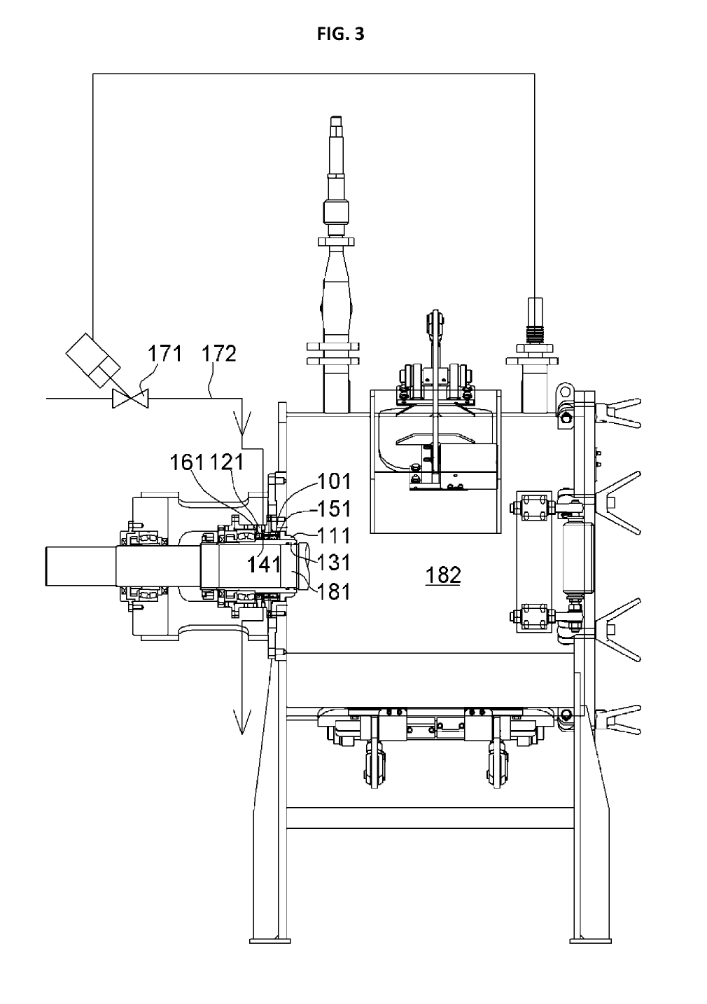

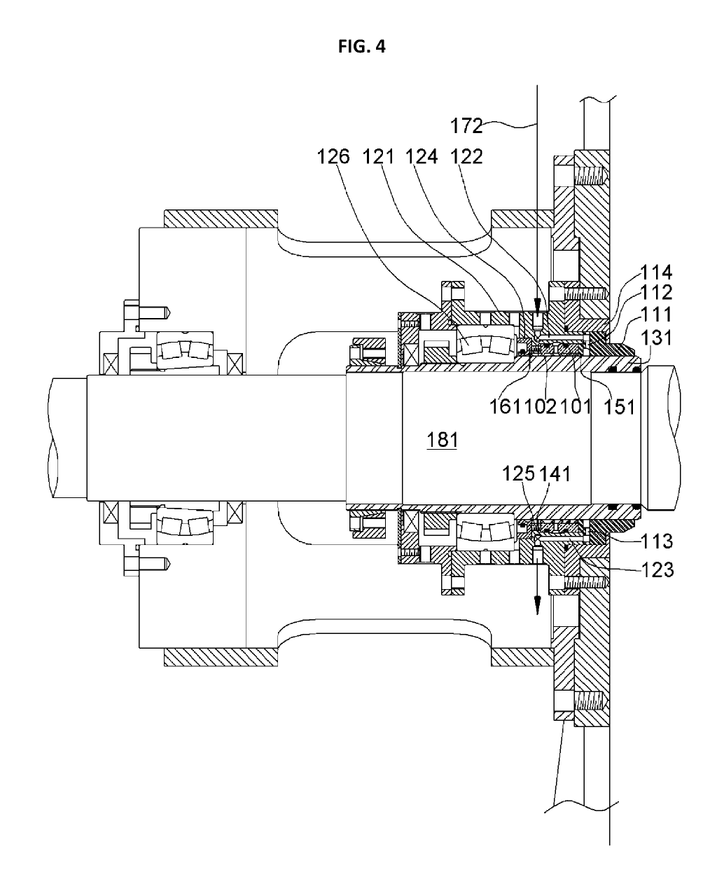

FIG. 3 is a diagram illustrating a dough penetration prevention device mounted in a kneading machine of the present invention; and FIG. 4 is a diagram explaining an example of a configuration of the dough penetration prevention device of the present invention, in which a dough, such as flour, rice, and the like to be kneaded, is put into the kneading container 182, and water or other liquid to be combined is added thereto.

Then, once a start button of a control box (not shown) is pressed, the rotating shaft 181 of the present invention rotates by power transferred from an external motor and a power transfer device (not shown), and steam at a proper temperature is supplied by a separate line into the kneading container 182 for smooth mixture.

Once the rotating shaft 181 rotates, the sleeve 131 connected to one side of the rotating shaft 181 rotates along with the rotating shaft 181.

The other side of the rotating shaft 181 is supported by a bearing connected to the kneading machine, and the outer circumference of the sleeve 131 is supported by the main bearing 126 connected to the bearing housing 121 of the kneading machine, thereby enabling smooth rotation.

Accordingly, kneading is performed in such a manner that a stirring piece (not shown), connected to a front end portion at one side of the rotating shaft 181, stirs and mixes the dough in the kneading container 182.

As described above, during rotation of the rotating shaft 181 and the sleeve 131, the dough in the kneading container 182 spreads to the inner circumferential surface of the kneading container 182, to come into contact with one side portion of the rotating shaft 181, one side portion of the sleeve 131, and one side portion of the head seal body 111, which are exposed toward the kneading container 182.

In this case, the control box senses the pressure of steam supplied into the kneading container 182, and opens an automatic opening-closing valve 171, as illustrated in FIG. 3, to supply pressure equivalent to the steam pressure of the kneading container 182.

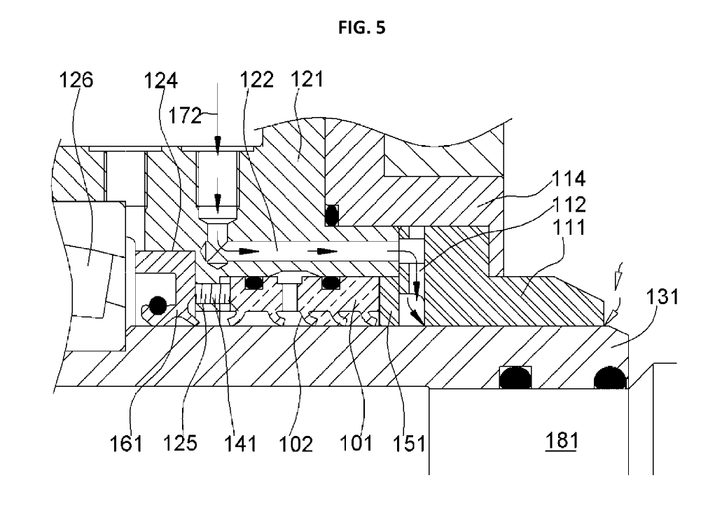

By opening the automatic opening-closing valve 171, steam provided from an external source is supplied along the connection line 172 to the steam guide passage 122 formed at the bearing housing 121, and then is fed into the steam guide hole 112 of the head seal body 111 which is connected to the steam guide passage 122, as illustrated in FIG. 5.

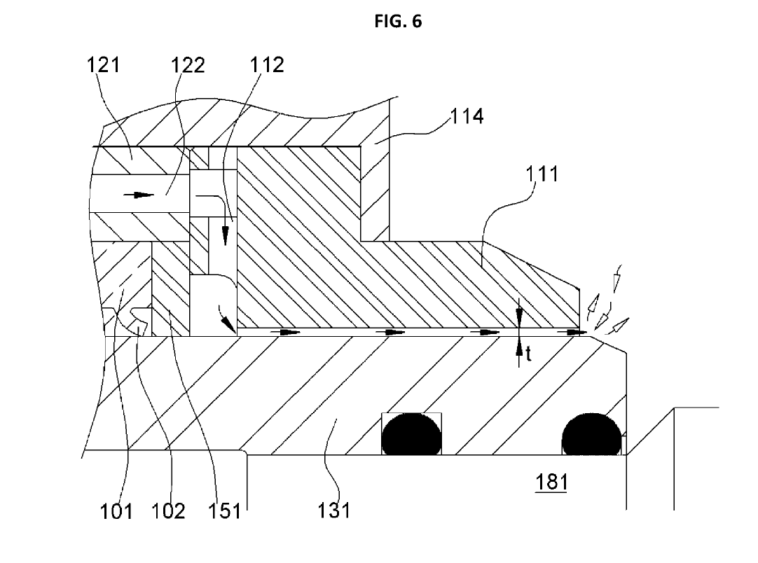

The steam fed into the steam guide hole 112 is supplied into a small gap (t) formed between an inner circumferential surface of the head seal body 111 and an outer circumferential surface of the sleeve 131 which is connected thereto, and the steam supplied into the small gap (t) is supplied along the gap (t) toward the kneading container 182 which is on the opposite side, as illustrated in FIG. 6.

The pressure of steam supplied through the gap (t) from the steam guide hole 112 to the kneading container 182 is equivalent to the pressure of steam attempting to penetrate toward the steam guide hole 112 through the gap (t) from the kneading container 182 on the opposite side, thereby offsetting the steam, and preventing the steam from penetrating through the gap (t), and the steam merely turns around inside the kneading container 182.

Accordingly, as the steam of the kneading container 182 fails to penetrate through the gap (t), the dough is prevented from being deposited at the entrance of the gap (t) of the kneading container 182, and scale of dough is not formed which is caused when the dough is deposited and hardens.

Further, the pressure in the kneading container 182 is changed frequently according to a mixed degree of the dough, such that in response to the pressure change, the automatic opening-closing valve 17 is repeatedly opened and closed according to an instruction of the control box to respond to the pressure change of the kneading container 182.

In addition, the pressure of steam supplied from the steam guide hole 112 to the kneading container 182 through the gap (t) should be at least equal to the pressure of the kneading container 182, but no significant problem will occur even when the pressure of steam supplied from the steam guide hole 112 is a little higher than the pressure of the kneading container 182.

Moreover, condensed water from the steam, having been fed into the steam guide hole 112 and completed its function, is discharged to the outside through a condensed water discharge hole 113 formed on the opposite side of the head seal body 111 and the steam guide hole 112, as illustrated in FIGS. 3 and 4.

However, in unexpected emergency situations, such as a case where the pressure of steam supplied from the steam guide hole 112 into the kneading container 182 through the gap (t) is lower than the pressure of the kneading container 182, or a case where supply of steam is stopped, the dough may penetrate through the gap (t) between the head seal body 111 and the sleeve 131 along with steam.

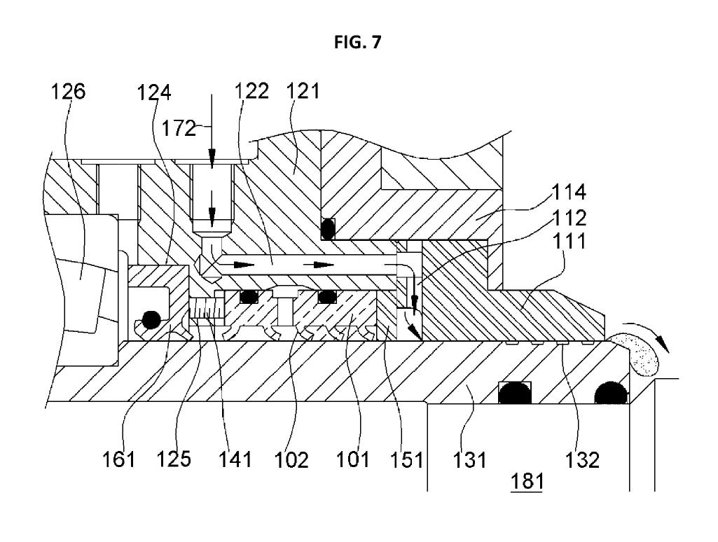

In this case, the screw grooves 132, formed on the outer circumferential surface of the rotating sleeve 131, pushes the dough toward the kneading container 182 as illustrated in FIG. 7, such that a penetrating portion of the dough may not pass through the screw grooves 132, and is put back in place into the kneading container 812 to be mixed with the remaining dough.

Further, the plurality of stopper screws 141 coupled to the plurality of screw holes 125 formed at a protruding portion of the bearing housing 121 may prevent the lip seal ring 101 from rotating along with the sleeve 131.

In addition, the first blocking seal ring 151, which is connected between the head seal body 111 and the lip seal ring 101, is provided as a first preliminary sealing member to prevent the dough, having passed through the gap between the head seal body 111 and the sleeve 131, from penetrating into the lip seal ring 101.

Moreover, the second blocking seal ring 161, which is mounted in an oil chamber 124 of the bearing housing 121, is provided as a second preliminary sealing member to prevent the dough, having passed through a space between the lip seal ring 101 and the sleeve 131, from penetrating into the main bearing 126.

Further, not only the dough but also high-temperature water or compressed air, which penetrates from the kneading container 182, may be prevented from penetrating into a space between the inner circumferential surface of the head seal body 111 and the outer circumferential surface of the sleeve 131.

The present invention has effects in that: by providing a lip seal ring having a plurality of seal ring wings which are integrally formed, the seal ring wings may be formed to have a larger thickness than that of a conventional seal ring wing, thereby improving sealing performance and extending the life of the lip seal ring, and the lip seal ring may be assembled to the bearing housing in a single process, thereby improving assembly productivity.

The present invention also has effects in that: by providing a head seal body mounted on the sleeve in front of the bearing housing to which the lip seal ring is connected, the lip seal ring may be isolated and prevented from coming into contact with the dough in the kneading container; and by providing a steam supply and discharge part which supplies steam, at a pressure level equal to the pressure of the kneading container, toward the kneading container to offset a pressure difference, the dough in the kneading container may be prevented from penetrating between the sleeve and the lip seal ring, thereby achieving excellent sealing performance, and preventing in advance deposition of scale of dough between the sleeve and the head seal body, and thus protecting the lip seal ring from the dough.

Further, the present invention has an effect in that by providing a screw groove formed at an outer circumferential surface at one side of the sleeve, even when the dough penetrates into a gap between the head seal body and the sleeve, the screw groove rotates along with the sleeve, so as to push the penetrating portion of the dough toward the kneading container, thereby maintaining the gap between the head seal body and the sleeve in a clean state.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A dough penetration prevention device of a kneading machine comprises:
a lip seal ring having a plurality of seal ring wings, which are integrally formed on s an inner circumferential surface of the lip seal ring and are fixed to a bearing housing, so as to prevent penetration of a dough, caused by steam pressure of a kneading container, into a main bearing in a bearing housing which is provided to assist rotation of a sleeve connected to a rotating shaft;
a head seal body which is mounted on the sleeve in front of the bearing housing and is fixed by a fixing body, so as to supply steam at a pressure level equal to the pressure of the kneading container into an opposite gap (t) between an outer circumferential surface of the sleeve and the lip seal ring, in opposition to the steam pressure of the kneading container attempting to penetrate into a gap (t) between the seal ring wings of the lip seal ring and the outer circumferential surface of the sleeve; and
a steam supply and discharge part which discharges condensed water, which is condensed by reacting with the steam of the kneading container, to the outside while supplying steam to an inner circumferential surface of the head seal body.

2. The device of claim 1, wherein the steam supply and discharge part comprises:
a steam guide hole which is formed at the other side of the head seal body and is supplied with steam;
a steam guide passage which is formed at the bearing housing connected to the steam guide hole, so as to supply steam at a predetermined pressure level to the steam guide hole;
an automatic opening-closing valve mounted on a connection line which is connected to a steam guide passage, so as to restrict an amount of steam supplied to the steam guide passage;
a condensed water discharge hole formed on an opposite side of the steam guide hole of the head seal body, so as to discharge the condensed water from steam having been supplied to the steam guide hole and completed its function; and
a condensed water discharge passage formed at the bearing housing connected to the condensed water discharge hole, so as to discharge the condensed water of the condensed water discharge hole to the outside.

3. The device of claim 1, further comprising a plurality of screw grooves which are formed on an outer circumferential surface of a sleeve, so as to push the dough of the kneading container, which has penetrated into the gap between the inner circumferential surface of the head seal body and the outer circumferential surface of the sleeve, toward the kneading container.

4. The device of claim 1, further comprising a plurality of stopper-screws, which are coupled to a plurality of screw holes formed at a protruding portion of the bearing housing, so as to prevent the lip seal ring from rotating along with the sleeve.

5. The device of claim 1, further comprising a first blocking seal ring, which is connected between the head seal body and the lip seal ring, so as to prevent the dough, having passed through the gap between the head seal body and the sleeve, from penetrating into the lip seal ring.

6. The device of claim 4, further comprising a second blocking seal ring, which is mounted in an oil chamber of the bearing housing, so as to prevent the dough, having passed through a space between the lip seal ring and the sleeve, from penetrating into the main bearing.
